(19) United States
(12) Patent Application Publication
(10) Pub. No.: US 2026/0085724 A1
(43) Pub. Date: Mar. 26, 2026

(54) BEARING DEVICE

(71) Applicant: NTN CORPORATION, Osaka (JP)

(72) Inventor: Masaki KATO, Mie (JP)

(21) Appl. No.: 19/331,585

(22) Filed: Sep. 17, 2025

(30) Foreign Application Priority Data
Sep. 26, 2024 (JP) 2024-167583

(51) Int. Cl. F16C 33/58; F16C 19/06

(52) U.S. Cl. CPC F16C 33/583; F16C 19/06; F16C 33/581; F16C 2226/16

(57) ABSTRACT

A bearing including an inner ring, an outer ring, and a plurality of rolling elements arranged between the inner ring and the outer ring, the inner ring including an annular portion and an extension portion protruding in an axial direction from an end surface of the annular portion on a radially inner side and having a slit formed in the axial direction; and a clamping member that is externally fitted to the extension portion, and is configured to clamp and fix the extension portion to a shaft. A radially inner end portion of the clamping member on a bearing side is provided with a stepped portion to which a radially outer end portion of the annular portion is allowed to be fitted.

### TECHNICAL FIELD

The present invention relates to a bearing device that is applied to, for example, a bearing unit to be used in general industrial machinery and the like.

### BACKGROUND ART

Various bearing units with alignment properties have been proposed. In related-art bearing units, a bearing bore and a shaft are clearance-fitted to each other in order to simplify assembly with the shaft, and the like, and set screws, eccentric collars, or tapered adapters are generally used as a device configured to fix a bearing and the shaft together (US 2021/0285497 A1, JP 3184486 U, JP 61-74913 A, JP 3055655 U, and US 4537519 B). Among those, a set screw type is often adopted. However, fastening the set screw inevitably causes misalignment of the shaft with respect to a rotation center of the bearing by an amount corresponding to a clearance between an inner diameter of an inner ring and the shaft, and hence there is a problem in that vibration increases as a rotation speed becomes higher. The same problem also arises when eccentric collars are used.

### Summary of Invention

### TECHNICAL PROBLEM

For this reason, bearings of a tapered adapter type are generally used under high-speed rotation. This tapered adapter type eliminates the clearance between the inner diameter of the inner ring and the shaft by work of tightening a tapered sleeve, and hence basically eliminates misalignment. Accordingly, the tapered adapter type is excellent in rotational accuracy and low vibration. However, the tapered adapter type requires more parts than the above-mentioned bearings, and requires a change in the internal structure in order to be used with the same shaft diameter as those of other types, resulting in an increased size of the entire bearing. Accordingly, there is a disadvantage in terms of workability and dimensional restrictions.

As a countermeasure against the foregoing, as disclosed in US 2021/0285497 A1 and the like, some bearings use a clamping member (concentric collar 106) that can mount a shaft and a bearing inner ring concentrically. That is, as illustrated in FIG. 6A, an inner ring 101 includes an annular portion 102, and an extension portion 103 protruding continuously in an axial direction from one end surface of the annular portion 102 on a radially inner side and having the same inner diameter as that of the annular portion 102. The extension portion 103 has a plurality of slits (splits) 104 formed in a circumferential direction so as to extend in the axial direction, thereby having a plurality of claw portions 105 in the circumferential direction.

Meanwhile, the concentric collar 106 is a snap ring that is discontinuous and has a gap (not shown) by being notched at one portion in the circumferential direction. A fastening bolt 107 provided in the circumferential direction is screwed into this gap, and both end portions opposed to each other through intermediation of a void are brought closer to each other, thereby reducing the void by clamping. Thus, the claw portions 105 are pressed by the concentric collar 106 and reduced in diameter, thereby being capable of fixing a shaft 108.

When clamping the concentric collar 106, the fastening bolt 107 provided in the circumferential direction is screwed into the gap as described above. However, at this time, the concentric collar 106 and an outer diameter of the extension portion 103 are clearance-fitted to each other, and hence a posture of the concentric collar 106 is not stable. Further, screwing-in operation of the fastening bolt 107 causes a force of circumferential motion about the fastening bolt 107. As illustrated in FIG. 6B, the force of this motion is the movement of the concentric collar 106 to tilt with respect to the bearing. Under a state in which the concentric collar 106 tilts with respect to the bearing, an amount of deformation (amount of reduction in diameter) of the claw portion 105 in the radial direction due to tightening of the concentric collar 106 is reduced, with the result that a shaft holding force of the bearing cannot be obtained. When the bearing imperfectly retains the shaft 108, the shaft 108 may run idle, which causes vibration, abnormal noise, and the like.

Accordingly, the present invention provides a bearing device that improves mounting workability of a clamping member and suppresses occurrence of bearing defects caused by a defective posture of the clamping member.

### SOLUTION TO PROBLEM

According to at least one embodiment of the present invention, there is provided a bearing device, comprising: a bearing comprising an inner ring, an outer ring, and a plurality of rolling elements arranged between the inner ring and the outer ring, the inner ring comprising an annular portion, and an extension portion protruding in an axial direction from an end surface of the annular portion on a radially inner side and having a slit formed in the axial direction; and a clamping member that is externally fitted to the extension portion, and is configured to clamp and fix the extension portion to a shaft. A radially inner end portion of the clamping member on a bearing side is provided with a stepped portion to which a radially outer end portion of the annular portion is allowed to be fitted.

In the bearing device according to at least one embodiment of the present invention, with the stepped portion being provided at the radially inner end portion of the clamping member on the bearing side, at the time of clamping of the clamping member, a radially inner surface of the clamping member in the stepped portion and the outer diameter of the inner ring (namely, the radially outer end portion of the annular portion) are brought into contact with each other. That is, during clamping work, the clamping member can be prevented from moving to tilt with respect to the bearing, and a posture of the clamping member during the clamping work can be stabilized in a correct state (while maintaining concentricity with the extension portion). This suppresses defective clamping without reducing an amount of deformation (amount of reduction in diameter) of the extension portion in the radial direction, and hence can prevent a shaft holding force of the bearing from being impaired due to the defective clamping.

The correct posture of the clamping member (maintaining concentricity with the extension portion) includes a case in which a center of the clamping member and a center of the extension portion are perfectly aligned and a case in which those centers are misaligned to an acceptable degree as an error. That is, "mounting in the correct posture" means a mounting state in which the shaft holding force of the bearing can be maintained. It can be said that, as long as the shaft holding force of the bearing is not impaired, the clamping member is mounted in the correct posture even when a tilt occurs.

In the above-mentioned configuration, it is preferred that a thickness of the extension portion in a radial direction be smaller than a maximum thickness of the annular portion in the radial direction. This can increase the flexibility of the extension portion, and can increase a fixing force between the extension portion and the shaft. Further, the radially outer end portion of the annular portion has a shoulder shape, which is easily fitted to the stepped portion.

In the above-mentioned configuration, it is preferred that an axial depth of the stepped portion be equal to or larger than an axial dimension of a chamfer formed on the radially outer end portion of the annular portion. This can ensure a sufficient space for entry of the radially outer end portion of the annular portion into the stepped portion, thereby being capable of further stabilizing the posture of the clamping member at the time of mounting.

In the above-mentioned configuration, it is preferred that a clearance in the radial direction between a radially inner surface of the clamping member in the stepped portion and the radially outer end portion of the annular portion be larger than a clearance between the radially inner surface of the clamping member and a radially outer surface of the extension portion. This prevents interference between the radially inner surface of the clamping member in the stepped portion and the annular portion of the inner ring when the clamping member is clamped, and hence can prevent the deformation of the extension portion from being inhibited by the above-mentioned interference.

An opening may be formed in the extension portion. With this configuration, rigidity of the extension portion can be lower than rigidity of the annular portion. This increases the fixing force between the inner diameter of the extension portion and the shaft when the bearing is fixed to the shaft, as compared to, for example, structures without any opening in the extension portion. Further, a processing range of the opening can be changed in accordance with an area of the extension portion, and hence can be applied to shapes of related-art extension portions, thereby being capable of obtaining further flexibility.

An outer peripheral surface of the outer ring may be provided in a bearing housing so as to be allowed to be aligned with a bearing housing. That is, the present invention is applicable to bearings with such an alignment function.

### ADVANTAGEOUS EFFECTS OF INVENTION

According to at least one embodiment of the present invention, with the formation of the stepped portion, the posture of the clamping member is stabilized during clamping work, thereby improving the mounting workability of the clamping member. Further, after clamping, the shaft holding force of the bearing can be prevented from being impaired due to the defective clamping, thereby being capable of suppressing defects of the bearing, such as abnormal noise and vibration, caused by a defective posture of the clamping member. Further, with the formation of the stepped portion only at one end side of the clamping member in the axial direction, the clamping member has a bilaterally asymmetrical shape, and a front side and a back side of the clamping member are identified without depending on visual check of indications such as inscriptions. This also has the advantage that the inscription or laser marking indicated on the front side of the clamping member can be omitted.

### BRIEF DESCRIPTION OF DRAWINGS

FIG. 1 is a sectional view of a bearing device according to a first embodiment of the present invention.

FIG. 2 is a perspective view of an inner ring that forms the bearing device.

FIG. 3 is an enlarged sectional view of a main part of FIG. 1.

FIG. 4 is a sectional view of a bearing device according to a second embodiment of the present invention.

FIG. 5 is a sectional view of a bearing unit, for illustrating an example in which the bearing device according to any one of the embodiments of the present invention is applied to the bearing unit.

FIG. 6A is a sectional view for illustrating a related-art bearing device under a state in which a concentric collar, which is a clamping member, does not tilt with respect to a bearing.

FIG. 6B is a sectional view for illustrating the related-art bearing device under a state in which the concentric collar tilts with respect to the bearing.

### DESCRIPTION OF EMBODIMENTS

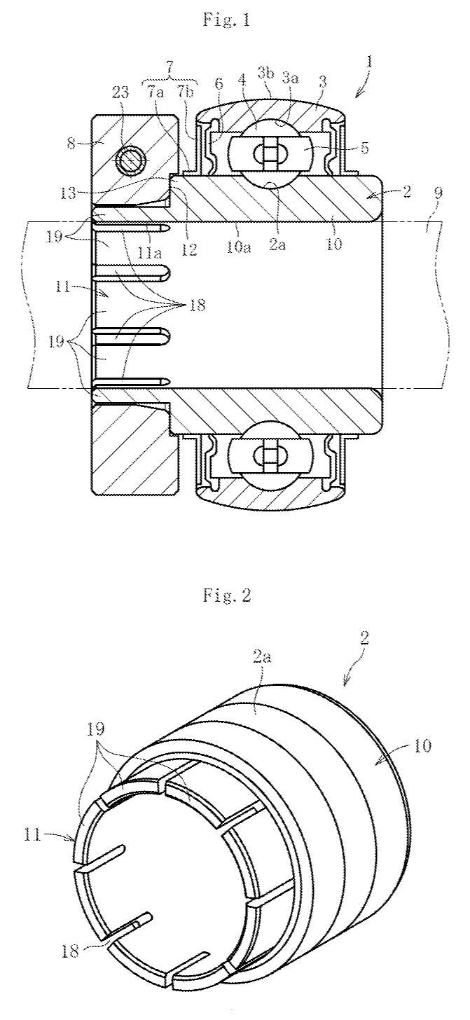

Now, a bearing device according to an embodiment of the present invention is described with reference to FIG. 1 to FIG. 5. This bearing device is applied to, for example, a bearing unit described later, which is used in general industrial machinery and the like.

As illustrated in FIG. 1, a bearing device according to a first embodiment comprises a bearing 1 and a clamping member 8. The bearing 1 is a ball bearing comprising an inner ring 2, an outer ring 3, a plurality of rolling elements 4 such as balls, a cage 5, seals 6, and slingers 7. The inner ring 2 and the outer ring 3 are made of bearing steel, and the balls 4 are formed of steel balls or the like. The inner ring 2 is formed to be wider than the outer ring 3, and comprises an annular portion 10 and an extension portion 11 as described later. An inner diameter of the inner ring and a shaft 9 are, for example, clearance-fitted to each other, and the extension portion 11 is mounted to the shaft 9 by the clamping member 8 (concentric collar).

An outer peripheral surface 3b of the outer ring 3 is formed into a convex spherical shape, and the outer peripheral surface 3b of the outer ring 3 is freely slidably fitted to a spherical radially inner portion of a bearing housing described later. Accordingly, the outer peripheral surface 3b of the outer ring 3 can be provided in the bearing housing so as to be allowed to be aligned with the bearing housing.

The plurality of rolling elements 4 are interposed between a raceway groove 2a of the inner ring 2 and a raceway groove 3a of the outer ring 3, and the cage 5 retains those rolling elements 4. Both ends of a bearing space of the inner ring 2 and the outer ring 3 are sealed by, for example, the seals 6 and 6 of a contact type. The bearing space is filled with grease, which is a lubricating oil.

Immediately outside of each seal 6 in an axial direction, the slinger 7 configured to further enhance sealing of the bearing space is provided. Each slinger 7 is formed to have an L-shaped cross section comprising a cylindrical portion 7a that is fitted and fixed to an outer peripheral surface of the inner ring, and an upright plate portion 7b that extends radially outward from an axial inner end of the cylindrical portion 7a. A radially outer end of the upright plate portion 7b is opposed to an inner peripheral surface of the outer ring through intermediation of a predetermined radial gap.

As illustrated in FIG. 1, the inner ring 2 comprises: the annular portion 10 arranged on a radially inner side of the outer ring 3; and the extension portion 11 protruding continuously in the axial direction from one end surface of the annular portion 10 on the radially inner side, and having the same inner diameter as an inner diameter 10a (see FIG. 1) of the annular portion 10. As illustrated in FIG. 1 and FIG. 2, the extension portion 11 has a plurality of (eight in the example illustrated in FIG. 2) slits (splits) 18 formed in a circumferential direction so as to extend in the axial direction, thereby forming eight claw portions 19 in the circumferential direction. The number of the slits 18 between the claw portions 19 and 19 adjacent to each other in the circumferential direction is set appropriately in accordance with design specifications such as flexibility to be given to each claw portion 19 and a bearing size, and may be set to 7 or less or can be increased to 9 or more.

As illustrated in FIG. 1, a thickness of the extension portion 11 in a radial direction is smaller than a maximum thickness of the annular portion 10 in the radial direction, and is, for example, about 50% of the maximum thickness of the annular portion 10 in the radial direction. This can increase the flexibility of the extension portion 11, and can increase a fixing force between the extension portion 11 and the shaft 9. Further, a radially outer end portion 13 of the annular portion 10 has a shoulder shape, which is easily fitted to a stepped portion 12 described later.

The clamping member 8 has a circumferential gap (not shown) formed by notching one portion in the circumferential direction, and this gap allows the clamping member 8 to be reduced in diameter. When a fastening bolt 23 is screwed into a void portion of the clamping member 8 near the gap, both end portions of the clamping member 8 are brought closer to each other to reduce the gap. As a result, the clamping member 8 is reduced in diameter, and a radially inner surface 11a of the extension portion (see FIG. 1) presses an outer peripheral surface of the shaft 9, thereby concentrically and easily fixing the inner ring 2 and the shaft 9 to each other.

As illustrated in FIG. 1, the stepped portion 12 is formed at a radially inner end portion of the clamping member 8 on the bearing side. That is, as illustrated in FIG. 3, on the radially inner side of the clamping member 8, there are provided an axial surface 14 facing a distal end side of the extension portion 11, a first tapered surface 15 increasing in diameter from the axial surface 14 toward the bearing side, and a second tapered surface 16 further increasing in diameter from the first tapered surface 15 toward the bearing side. On the bearing side with respect to the second tapered surface 16, the stepped portion 12 is formed by cutting out the radially inner end portion of the clamping member 8. This stepped portion 12 allows entry of the radially outer end portion 13 of the annular portion 10 of the inner ring 2, and is also allowed to be fitted to the radially outer end portion 13 having a shoulder shape.

With the provision of the stepped portion 12 described above, at the time of clamping of the clamping member 8, a radially inner surface 17 of the clamping member 8 in the stepped portion 12 and the outer diameter of the inner ring (namely, the radially outer end portion 13 of the annular portion 10) are brought into contact with each other. That is, during clamping work, the clamping member 8 can be prevented from moving to tilt with respect to the bearing 1 (for example, making circumferential motion about the fastening bolt 23), and hence a posture of the clamping member 8 during the clamping work can be stabilized in a correct state (while maintaining concentricity with the extension portion 11). This suppresses defective clamping without reducing an amount of deformation (amount of reduction in diameter) of the extension portion 11 in the radial direction, and hence can prevent a shaft holding force of the bearing 1 from being impaired due to the defective clamping.

The correct posture of the clamping member 8 (maintaining concentricity with the extension portion 11) includes a case in which a center of the clamping member 8 and a center of the extension portion 11 are perfectly aligned and a case in which those centers are misaligned to an acceptable degree as an error. That is, "mounting in the correct posture" means a mounting state in which the shaft holding force of the bearing 1 can be maintained. It can be said that, as long as the shaft holding force of the bearing 1 is not impaired, the clamping member 8 is mounted in the correct posture even when a tilt occurs.

As illustrated in FIG. 3, it is preferred that an axial depth D of the stepped portion 12 be equal to or larger than an axial dimension "d" of a chamfer 13a formed on the radially outer end portion 13 of the annular portion 10. This can ensure a sufficient space for entry of the radially outer end portion 13 of the annular portion 10 into the stepped portion 12, thereby being capable of further stabilizing the posture of the clamping member 8 at the time of mounting.

Further, it is preferred that a radial clearance δ1 between the radially inner surface 17 of the clamping member 8 in the stepped portion 12 and a radially outer surface 10b of the annular portion 10 of the inner ring 2 be larger than a clearance δ2 between the radially inner surface of the clamping member 8 (axial surface 14 located on the most radially inner side among the axial surface 14, the first tapered surface 15, and the second tapered surface 16) and a radially outer surface 11b of the extension portion 11. This prevents interference between the radially inner surface 17 of the clamping member 8 in the stepped portion 12 and the annular portion 10 of the inner ring 2 when the clamping member 8 is clamped, and hence can prevent the deformation of the extension portion 11 from being inhibited due to the above-mentioned interference.

In the bearing device according to at least one embodiment of the present invention, with the formation of the stepped portion 12, the posture of the clamping member 8 is stabilized during clamping work, thereby improving the mounting workability of the clamping member 8. Further, after clamping, the shaft holding force of the bearing 1 can be prevented from being impaired due to the defective clamping, thereby being capable of suppressing defects of the bearing 1, such as abnormal noise and vibration, caused by a defective posture of the clamping member 8. Further, with the formation of the stepped portion 12 only at one end side of the clamping member 8 in the axial direction, the clamping member 8 has a bilaterally asymmetrical shape, and hence a front side and a back side of the clamping member 8 are identified without depending on visual check of indications such as inscriptions. This also has the advantage that the inscription or laser marking indicated on the front side of the clamping member 8 can be omitted.

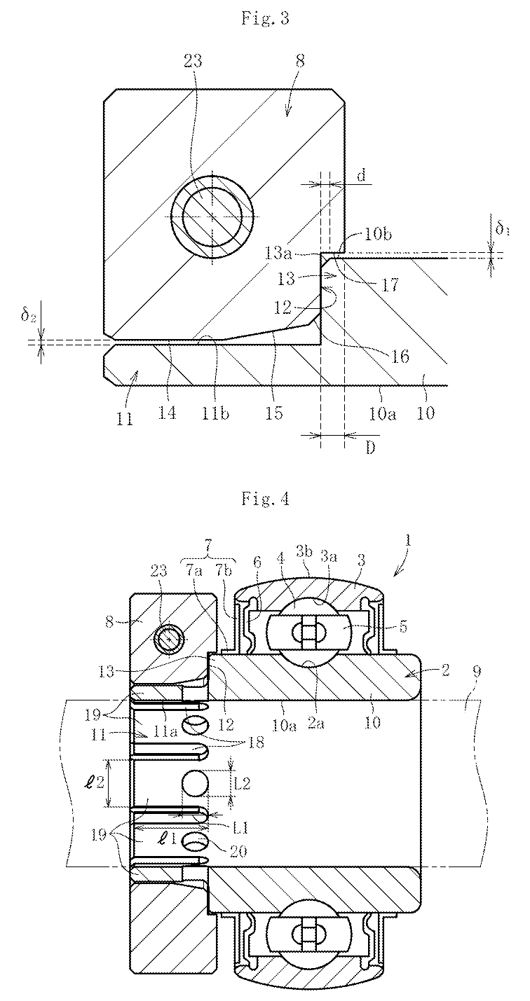

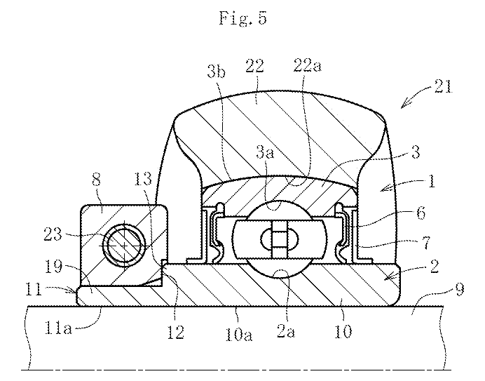

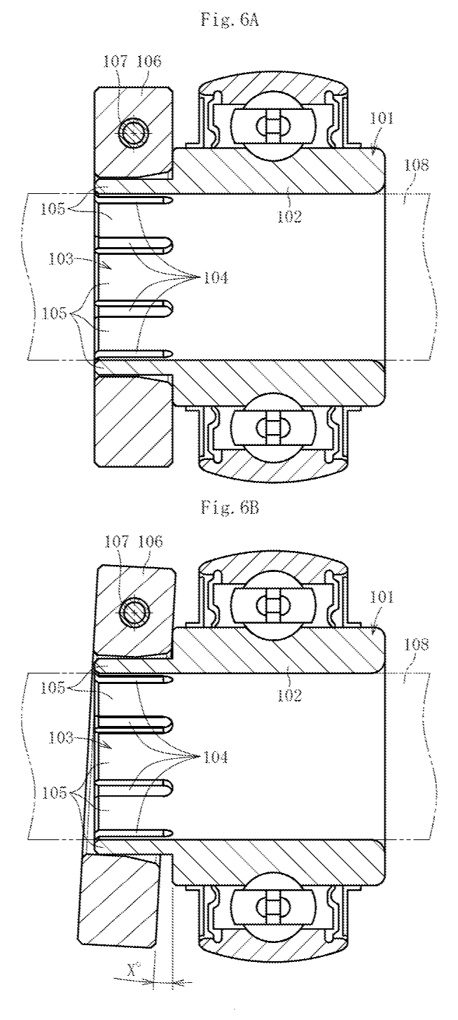

Next, FIG. 4 shows a bearing device according to a second embodiment. In the bearing device according to the second embodiment, an opening 20 is formed in each of the claw portions 19 of the extension portion 11. The opening 20 is a through hole having a round hole shape extending through the claw portion 19 in the radial direction. However, the opening 20 is not limited to having a round hole shape, but may have, for example, a quadrangular hole shape. It is preferred that an axial position of the opening 20 be more on the raceway groove 2a side of the inner ring 2 than an axial middle portion of the claw portion 19. In FIG. 4, the opening 20 is formed at a root of the claw portion 19.

It is preferred that an axial length L1 of the opening 20 be 50% of an axial length l1 of the claw portion 19 at the maximum. Further, it is preferred that a circumferential length L2 of the opening 20 be 60% of a circumferential length l2 of the claw portion 19 at the maximum. This can suppress a reduction in contact range between the inner diameter of the claw portion 19 and the shaft 9. When the axial length L1 of the opening 20 exceeds 50% of the axial length l1 of the claw portion 19, or the circumferential length L2 of the opening 20 exceeds 60% of the circumferential length l2 of the claw portion 19, the contact range between the inner diameter of the claw portion 19 and the shaft 9 decreases, with the result that it is difficult to maintain the fixing force between the inner diameter of the claw portion 19 and the shaft 9.

With the above-mentioned configuration, the bearing device according to the second embodiment also has the same operations and effects as those of the bearing device according to the first embodiment. In addition, the bearing device according to the second embodiment has the opening 20 formed in each of the claw portions 19, and hence rigidity of the claw portion 19 can be lower than rigidity of the annular portion 10. This increases the fixing force between the radially inner surface 11a of the extension portion and the shaft 9 when the bearing 1 is fixed to the shaft 9, as compared to, for example, structures without the opening 20 in the claw portion 19. Further, a processing range of the opening 20 can be changed in accordance with an area of the extension portion 11, and hence can be applied to shapes of related-art extension portions, thereby being capable of obtaining further flexibility. In the bearing device according to the second embodiment illustrated in FIG. 4, the same components as those of the bearing device according to the first embodiment are denoted by the same reference symbols as in FIG. 1, and description thereof is omitted.

FIG. 5 is a longitudinal sectional view of a bearing unit 21, for illustrating an example in which the bearing device according to any one of the embodiments is applied to the bearing unit. The bearing unit 21 comprises: a bearing housing 22; the bearing 1 that is provided in the bearing housing 22 so as to be allowed to be aligned with the bearing housing 22; and the clamping member 8. An inner periphery of the pillow-shaped bearing housing 22 has a concave spherical radially inner portion 22a. The bearing unit 21 exerts an alignment function when the outer peripheral surface 3b of the bearing 1, which is the convex spherical radially outer portion of the outer ring, is freely slidingly fitted to the spherical radially inner portion 22a of the bearing housing 22. In the bearing unit illustrated in FIG. 5, the same components as those of the bearing device according to the first embodiment are denoted by the same reference symbols as in FIG. 1, and description thereof is omitted.

The embodiments of the present invention have been described above, but the present invention is not limited to the embodiments described above, and various modifications can be made thereto. In the embodiments, the bearing 1 is a ball bearing, but may also be a tapered roller bearing, a cylindrical roller bearing, or the like. The number of the claw portions 19 can be set freely selectively. When a plurality of claw portions 19 are provided, circumferential lengths of the claw portions 19 may be the same or different, and an axial length and a circumferential width of each slit 18 may be the same or different. The seal 6 may be a non-contact seal, or the slinger 7 may be omitted. The axial and radial depths of the stepped portion 12 can be set freely selectively in accordance with the dimensions and the like of the chamfer 13a of the radially outer end portion 13.

In the second embodiment, it is not required to form the openings 20 in all of the claw portions 19, but it is also possible to configure at least any one of the claw portions 19 to have the opening 20. In this case, the number of processing man-hours can be reduced, and hence manufacturing cost can be reduced, as compared to a case of forming the openings 20 in all of the claw portions 19. When a plurality of openings 20 are formed, hole diameters and shapes of the openings 20 may be the same or different. The opening 20 may be a non-through hole in the form of a so-called counter bore formed in an inner peripheral surface or outer peripheral surface of the claw portion 19.

### Reference Signs List

1 bearing

2 inner ring

3 outer ring

4 ball

8 clamping member

9 shaft

10 annular portion

11 extension portion

12 stepped portion

13 radially outer end portion

13a chamfer

19 slit

20 opening

22 bearing housing

D axial depth of stepped portion

d axial dimension of chamfer

δ1 radial clearance

δ2 radial clearance

1. A bearing device, comprising:
a bearing comprising an inner ring, an outer ring, and a plurality of rolling elements arranged between the inner ring and the outer ring,
the inner ring comprising an annular portion, and an extension portion protruding in an axial direction from an end surface of the annular portion on a radially inner side and having a slit formed in the axial direction; and
a clamping member that is externally fitted to the extension portion, and is configured to clamp and fix the extension portion to a shaft,
wherein a radially inner end portion of the clamping member on a bearing side is provided with a stepped portion to which a radially outer end portion of the annular portion is allowed to be fitted.

2. The bearing device according to claim 1, wherein a thickness of the extension portion in a radial direction is smaller than a maximum thickness of the annular portion in the radial direction.

3. The bearing device according to claim 1, wherein an axial depth of the stepped portion is equal to or larger than an axial dimension of a chamfer formed on the radially outer end portion of the annular portion.

4. The bearing device according to claim 1, wherein a clearance in the radial direction between a radially inner surface of the clamping member in the stepped portion and the radially outer end portion of the annular portion is larger than a clearance between the radially inner surface of the clamping member and a radially outer surface of the extension portion.

5. The bearing device according to claim 1, wherein an opening is formed in the extension portion.

6. The bearing device according to claim 1, wherein an outer peripheral surface of the outer ring is provided in a bearing housing so as to be allowed to be aligned with the bearing housing.
